(19) United States
(12) Patent Application Publication
(10) Pub. No.: US 2004/0059798 A1
(43) Pub. Date: Mar. 25, 2004

(54) Adaptive mobile agents

(76) Inventors: Roch Glitho, Montreal (CA); Samuel Pierre, Laval (CA); Sylvain Methot, Laval (CA)

Correspondence Address: SANDRA BEAUCHESNE, Ericsson Canada Inc., Patent Department (LMC/UP), 8400 Decarie Blvd., Town Mount Royal, QC, H4P 2N2, CA

(21) Appl. No.: 10/252,715

(22) Filed: Sep. 24, 2002

(51) Int. Cl. G06F 15/16; G06F 15/173

(52) U.S. Cl. 709/219; 709/224

(57) ABSTRACT

The present invention is directed to a Mobile Agent (MA) and a method of migrating a MA having a set of partitions from a current host to a target host. The MA comprises a communication module capable of, prior to migrating to the target host, getting information on available resources at the target host. The MA further comprises a partition handler. The partition handler is capable of electing partitions to be dropped by the MA and sending the elected partitions to a Partition Storage Agent (PSA). The partition handler elects the partitions to be dropped from the set of partitions and the information on available resources at the target host. The partition handler is further capable of, after migrating to the target host, downloading new partitions from the PSA.

### BACKGROUND OF THE INVENTION

1. Field of the Invention

The present invention relates generally to computer technology, and in particular to mobile agents.

2. Description of the Related Art

Execution of a program requires three components: code component, resources component (i.e. data), and computational component (i.e. processing capabilities). In the various code mobility paradigms—remote evaluation, code on demand, and mobile agent—the three components are treated in different ways.

In remote evaluation, node A hosts only the code component. In order to execute the program, node A sends a request to node B, along with the code, and gets back the results of the execution.

In code on demand, node A hosts the resource component and the computational component, but lacks the code component. In order to execute the program, node A gets the code from node B, and the carries out the execution.

In mobile agent, node A hosts the code, but may lack some of the required resources. The code is sent, with any intermediate results, to node B where execution resumes.

Mobile agents are thus, broadly speaking, a software entity with a certain amount of autonomy. It acts on behalf of another entity and reacts to external events. As such, they can start execution in a host, suspend execution, and the move to another host to resume execution. The concept is rooted in process migration and has raised considerable interest, primarily in the research community, since they emerged in the mid-90s.

The execution of mobile agents requires a specific environment, the agent execution environment, also known as platform. Nowadays, mobile agent platforms are usually implemented as Java applications that run on top of operating systems, although other implementations have been attempted in the past.

The claims as to the usefulness of mobile agents are numerous, e.g. enhanced flexibility, reduced bandwidth consumption, improved fault tolerance and support for disconnected operations.

The current Internet infrastructure comprises an extensive range of hosts, or clients, ranging from high-end computers with much memory and processing power, to devices such as personal digital assistants (PDAs) with relatively limited memory and processing power.

It can therefore be appreciated that it is difficult to construct mobile agents that can utilise the whole of the memory/processing power spectrum. If a mobile agent requires too much resources (either memory, processing power, or both), then it cannot reside on devices with relatively limited resources. On the other hand, mobile agents created to be able to reside on these resource-limited devices, may often be too limited in performance.

There have been several attempts over the years to adapt applications to terminal's variability and network conditions. The focus has been on wireless environments. To classify these attempts, several schemes, such as the mobile aware scheme, can be used. In this scheme, at one extreme the adaptation is completely left to the infrastructure, while at the other extreme, it is completely left to the application.

Proxies are at the first extreme. They are interposed between the server and the client and handle the adaptation.

An approach pertaining to the second extreme has been proposed in “Partitioning Applications with Agents” (O. Koskimies and K. Raatikainen, Second International Workshop on Mobile Agents for Telecommunication Applications, MATA2000, pp. 79-93). In the approach, applications are partitioned as mobile agents. The partition is fully dynamic in the sense that the component agents can move anytime while the application is running. This mobility is required in order to be able to adapt to network conditions because these conditions can change anytime, especially in wireless environments. It is not required for adapting to terminals' variability. Partially dynamic partitioning suffices. The component agents just need to be located on either the client or the server side when the application is initiated. There is no need to move them around while the application is running.

Proxies cannot aid solve the problem at hand. They rely on the assumption that the application is a client/server application. However, the logic implemented by a mobile agent does not necessarily follow the client/server paradigm.

Mobile agent based application partitioning is much more pertinent for the problem at hand. However, there is a serious performance issue in the mobile agent based application partitioning approach hereinbefore. When memory and/or processing power become abundant, the partitions continue using inter-agent communications mechanisms although they reside on the same host. The penalty for this in terms of performance is quite heavy.

It can be appreciated that it would be advantageous to have solution for mobile agents that overcomes disadvantages of the prior art and provides mobile agents that are flexible. This invention provides such a solution.

### SUMMARY OF THE INVENTION

The present invention is directed to a Mobile Agent (MA) having a set of partitions. The MA is capable of migrating from a current host to a target host. The MA comprises a communication module capable of, prior to migrating to the target host, getting information on available resources at the target host. The MA further comprises a partition handler. The partition handler is capable of electing partitions to be dropped by the MA and sending the elected partitions to a Partition Storage Agent (PSA). The partition handler elects the partitions to be dropped from the set of partitions and the information on available resources at the target host. The partition handler is further capable of, after migrating to the target host, downloading new partitions from the PSA.

The present invention is further directed to a method for migrating a Mobile Agent (MA) having a set of N partitions from a current host to a target host. The method comprises steps of, prior to migrating, getting, by the MA, information on available resources at the target host and calculating, at the MA, a number M of partitions the target host can accommodate. In the case where M equals N, the method further comprises step of migrating the MA from the current host to the target host. In the case where M is smaller than N, the method further comprises steps of asking a partition handler to elect N−M partitions to be dropped by the MA, asking the partition handler to send the elected N−M partitions to a Partition Storage Agent (PSA), building at the MA proxies through which sent N−M partitions can be accessed and migrating the MA from the current host to the target host. In the last case where M is greater than N, the method further comprises steps of asking the partition handler to elect the M−N partitions to download from the PSA and migrating the MA from the current host to the target host. In the last case, upon migration to the target host, the method further comprises steps of checking at the MA if there is at least one new partition to be downloaded from the PSA and, if at least one new partition is to be downloaded from the PSA, downloading the at least one new partition to the MA and destroying at the MA proxy associated with the at least one new partition.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is a block chart of a mobile agent environment in which a preferred embodiment of the invention is implemented.

### DETAILED DESCRIPTION OF THE PREFERRED EMBODIMENTS

The innovative teachings of the present invention will be described with particular reference to numerous exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views, and the various elements depicted are not necessarily drawn to scale.

An exemplary mobile agent, a mobile service agent (MSA) providing services to users, will hereinafter be used to facilitate comprehension of the description of the invention. The mobile service agent (MSA) is the key entity. It acts as a folder, and carries the services to which end-users have subscribed. For each one of the services, it carries the logic (i.e. the executable code) and the data. Any and every given service for which the user has a subscription is normally carried by one and only one MSA. The number of MSAs per user may vary; it is possible to have just one MSA per subscriber, and the MSA carries all the services to which the user has subscribed.

In the description, it is assumed that the mobile agent is designed with partitioning in mind. This assumption has three implications. The first is that the agent is designed as a set of loosely coupled partitions that can be executed either locally or remotely. The second is that the agent is able to get information on the memory and/or processing power available at the target host, prior to the migration to the host. The information can be acquired by a communication module of the Mobile Agent via well-known networking protocols such as, for example, Simple Network Management Protocol (SNMP). The third is that agent can perform dedicated partitioning operations.

It is also assumed that there is at least one host in the network, with enough processing power and/or memory capacity, to accommodate the partitions the mobile agent cannot keep and/or execute locally because of processing power and/or memory capacity constraints.

It is further assumed that every host to which the agent can potentially migrate to has a minimal processing power and memory capacity required by the mobile agent environment or framework. As explained later in the paper, this is due to the fact that the framework requires the agent to always keep some partitions.

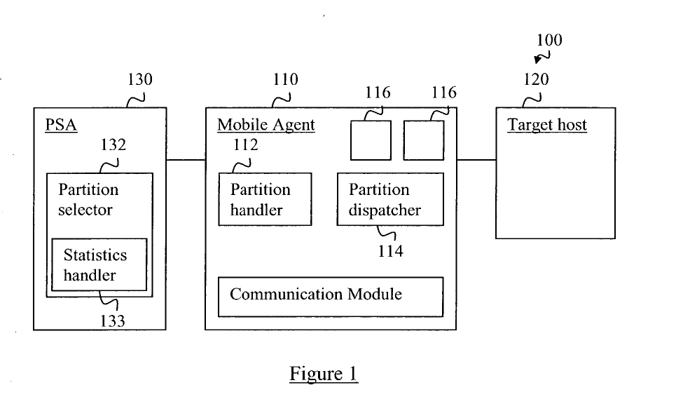

Referring now to the figures, wherein FIG. 1 is a block chart of a mobile agent environment in which a preferred embodiment of the invention is implemented. The mobile agent environment 100 comprises a mobile agent 110, a partition storage agent (PSA) 130, and a target node 120. The target node 120 is the node the mobile agent 110 is about to move to.

The mobile agent 110 comprises a partition handler 112, a partition dispatcher 114, and a number of partitions 116, e.g. made up of data and executable code for a service. The PSA 130 comprises a partition selector 132. It should e.g. be noted that the partition selector 132 could also be comprised in the mobile agent 110.

The PSA 130 stores partitions 116 that mobile agents have elected to drop, i.e. not bring along to the node where they currently reside. The PSA 130 may be fixed or mobile and resides on a host distinct from the host on which the mobile agent 110 being partitioned resides. As per the assumptions, this host (not shown) of the PSA 130 has the required processing power and memory capacity to accommodate all the partitions 116 the mobile agent 110 drops.

The partition handler 112 is a high level operation that relies on two lower level operations: the partition dispatcher 114 and partition selector 132. The partition dispatcher 114 sends away the partitions 116 the mobile agent 110 has elected to drop when memory and/or processing power is scarce, and gets back the partitions 116 that the mobile agent 110 has decided to claim back when memory and/or processing power becomes more available.

The partition handler 112 is a partition the mobile agent 110 always carries. It acts as a co-ordinator, as will be seen hereinafter with respect to e.g. its pre-migration, post-migration and partition replacement schemes.

As an explanatory example, the mobile agent 110 has N partitions. For simplicity sake, we assume that the partitions have the same size. However, it should be understood that partitions from different sizes could be used without affecting the essence of the present invention. There are at least two options for selecting the M (M<=N) partitions 116 the mobile agent 110 should have when it reaches the target host. The first option comprises making sure the mobile agent 110 keeps as many partitions 116 as possible from the set it currently has. This will reduce the number of partitions 116 to send away and later claim back. The second option comprises asking the partition selector 132 to select the M partitions 116 independently of the N partitions 116 the mobile agent 110 currently has.

According to the first option, if M is less than N, then the partition handler 112 will ask the partition selector 132 to select the M partitions 116 that should be kept. The remaining N−M partitions 116 are sent to the PSA 130. If M is greater than N, then the partition selector 132 is asked to select the M−N partitions 116 the mobile agent 110 should download as soon as it reaches the target. If M is equal to N, then the mobile agent 110 will just move to the new target with the partitions 116 it already has.

According to the second option, M “new” partitions 116 are selected from the set of all existing partitions 116. When M is equal to N, an interesting case is when none of the partitions 116 currently kept by the mobile agent 110 is selected.

Prior to its migration, the mobile agent 110 sends the N partitions it has to the PSA 130, and downloads the N partitions 116 selected by the partition selector 132. This will lead to 2N exchanges between the PSA 130 and the mobile agent 110 being partitioned.

The performance of each option depends on the schemes used for partition selection.

The first option is described hereinafter. The partition handler 112 takes the following steps prior to the departure of the agent:

1. It receives information on the memory and processing power available at the target host.

2. It computes the number M of partitions 116 the target host can accommodate.

3. If N=M then it moves to the host.

4. If N>M then it:

asks the partition selector 132 to select the N−M partitions 116 to drop,

asks the partition dispatcher 114 to send the elected partitions 116 to the PSA 130,

builds proxies through which dispatched partitions 116 can be accessed remotely,

moves to the target host.

5. If N<M then it:

asks the partition selector 132 to select the M−N partitions 116 to download when it reaches the target host,

moves to the target host.

When the mobile agent 110 reaches the new host, the partition handler 112:

1. Checks if there are partitions 116 to be downloaded,

2. If there are partitions to be downloaded, it:

asks the partition dispatcher 114 to download these partitions 116,

destroys the proxies that were used to remotely execute the partitions 116.

Partition replacement occurs when a partition 116 that can be executed only locally happens to be in the PSA 130. The partition handler 112 then:

1. Asks the partition selector 132 to select the partition 116 to be sacrificed.

2. Asks the partition dispatcher 114 to send the partitions 116 to be dropped to the PSA 130.

3. Asks the partition dispatcher 114 to download the needed partition 116.

The partition selector 132 selects the partitions 116 to drop when memory and/or processing power is scarce and the partitions 116 to claim back when memory and/or processing power becomes more abundant. This choice is based on a set of criteria, such as:

Mandatory local execution vs. optional local execution. Some partitions 116 can be executed only locally. A good example is a partition 116 that includes a graphical user interface. If a choice is to be made between a partition 116 that can be executed only locally, and another partition 116 that can be executed both locally and remotely, the preference should go to the first when it comes to the choice of the partition 116 the mobile agent 110 should keep.

Real time execution vs. non real time execution. Some partitions 116 need to be executed in real time, meaning there is an upper bound to the time lag between the invocation of the partition 116 and the start of the execution. If a choice is to be made between a partition 116 with real-time constraints and a partition 116 with no real time constraint, the preference should go to the first when it comes to the choice of the partition 116 the mobile agent 110 should keep.

High execution probability vs. low execution probability. Some partitions 116 are highly likely to be executed in the near future while others are not. If a choice is to be made between a partition 116 with a high execution probability and a partition 116 with a low execution probability, the preference should go to the first when it comes to the choice of the partition 116 the mobile agent 110 should keep.

The time lag between the invocation of a partition 116 and its execution can be quite important in an architectural framework 100. This happens for instance when the partition 116 to be executed can be executed only locally, but happens to be stored in the PSA 130. The mobile agent 110 will have to send to the PSA 130 one of the partitions 116 it carries, and then claim back the partition 116 to be executed.

A key goal for partition selection is to keep the average time between the invocation of partitions and the beginning of the actual execution as low as possible, while meeting the three criteria hereinabove. The criteria may be ranked, and this ranking will allow the selection of the proper partition 116 when for instance there is space for only one more partition 116 on the target host, and a choice is to be made between these partitions 116 such as:

a partition 116 that can execute only locally,

a partition 116 with real time constraints, and

a partition 116 with a high execution probability.

Thus, if there is a need to select M partitions 116 from a set of N partitions 116, with N>M and for example the following ranking (in decreasing order of priority):

Partitions 116 that can execute only locally,

Partitions 116 with real time constraints, and

Partitions 116 with high execution probability.

The partition selector 132 then takes the following actions:

1. It selects partitions 116 that can execute only locally.

2. If there is space left it selects partitions 116 with real time constraints.

3. If there is space left it selects partitions 116 with high execution probability.

Other algorithms using different criteria ranking schemes can easily be derived from the one described. The execution probability may vary during the whole life of the agent, while the two other criteria are fixed.

When ranking, such as the one described hereinbefore is used, it makes more sense for the partition handler 132 to use the first option (i.e. keep as many partitions 116 as possible from the set of partitions 116 the mobile agent 110 already has) of the pre-migration scheme. If the high execution probability vs. low execution probability was ranked the highest it will make more sense to use the second option.

Several algorithms have been proposed over the years for predicting the execution probability, especially in the context of operating systems. These algorithms are beyond the scope of the present invention. However, as most of the algorithms rely on what has happened in the past, a scheme is proposed for collecting and processing the relevant information. The scheme includes a statistics handler 133 that is part of the partition selector 132.

The partition handler 112 periodically sends execution statistics to the statistics handler 133.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A Mobile Agent (MA) having a set of partitions, the MA migrating from a current host to a target host, the MA comprising:
a communication module capable of, prior to migrating to the target host, getting information on available resources at the target host; and
a partition handler being capable of:
electing, from the set of partitions and the information on available resources at the target host, partitions to be dropped by the MA; and
sending the elected partitions to a Partition Storage Agent (PSA).

2. The MA of claim 1 where the partition handler is further capable of, after migrating to the target host, downloading new partitions from the PSA.

3. The MA of claim 1 where the step of electing the partitions to be dropped by the MA further comprises step of communicating with a partition selector within the PSA.

4. The MA of claim 1 where the partition handler further communicates with a partition dispatcher for sending the elected partitions to the PSA.

5. A method for migrating a Mobile Agent (MA) having a set of N partitions from a current host to a target host, the method comprising steps of:
prior to migrating, getting by the MA information on available resources at the target host;
prior to migrating, calculating at the MA a number M of partitions the target host can accommodate;
if M equals N, migrating the MA from the current host to the target host;
if M is smaller than N:
asking a partition handler to elect N−M partitions to be dropped by the MA;
asking the partition handler to send the elected N−M partitions to a Partition Storage Agent (PSA);
building at the MA proxies through which sent N−M partitions can be accessed; and
migrating the MA from the current host to the target host;
if M is greater than N:
asking the partition handler to elect the M−N partitions to download from the PSA; and
migrating the MA from the current host to the target host;
upon migration to the target host, checking at the MA if there is at least one new partition to be downloaded from the PSA;
if at least one new partition is to be downloaded from the PSA:
downloading the at least one new partition to the MA; and
destroying at the MA proxy associated with the at least one new partition.

6. The method of claim 5 where the MA further comprises a partition selector for electing the N−M partitions to be dropped by the MA.

7. The method of claim 5 where the partition handler further comprises a partition dispatcher for sending the elected N−M partitions to the PSA.

8. The method of claim 5 where the partition handler further comprises a partition dispatcher for downloading partitions from the PSA.
